(19) United States
(12) Patent Application Publication
(10) Pub. No.: US 2024/0389800 A1
(43) Pub. Date: Nov. 28, 2024

(54) Kitchen Appliance, Connecting Element and Method for Transmitting an Information Signal

(71) Applicant: Vorwerk & Co. Interholding GmbH, Wuppertal (DE)

(72) Inventors: Nils Beckmann, Remscheid (DE); Torsten Lang, Solingen (DE); Volker Wahle, Hamminkeln (DE); Thomas Bletek, Vettweiss (DE)

(21) Appl. No.: 18/673,543

(22) Filed: May 24, 2024

(30) Foreign Application Priority Data
May 25, 2023 (EP) 23175358.3

(51) Int. Cl. A47J 43/07

(52) U.S. Cl. CPC A47J 43/0727

(57) ABSTRACT

A kitchen appliance with a base unit, wherein the base unit has a first communication module configured for wireless communication, with a receiving vessel. The receiving vessel has a wall with a penetrating opening, and with an accessory part. The accessory part has a second communication module configured for wireless communication. In order to avoid a diversion of the signal transmission around the receiving vessel, it is proposed that a connecting element is provided, wherein the connecting element is intended for arrangement in the penetrating opening of the wall of the receiving vessel. The connecting element is adapted to transmit signals between the first communication module and the second communication module. Also described are a connecting element and a method for transmitting an information signal.

### CROSS-REFERENCE TO RELATED APPLICATION

This application claims priority to European Patent Application No. 23175358.3 filed May 25, 2023, the disclosure of which is hereby incorporated by reference in its entirety.

### BACKGROUND OF THE INVENTION

### Field of the Invention

The present invention relates to a kitchen appliance with a base unit, wherein the base unit has a first communication module configured for wireless communication, with a receiving vessel, wherein the receiving vessel has a wall with a penetrating opening, and with an accessory part, wherein the accessory part has a second communication module configured for wireless communication. The invention also relates to a connecting element for a kitchen appliance with a base body, wherein the base body is at least partially adapted for arrangement in a penetrating opening in the wall of a receiving vessel of the kitchen appliance. A method for transmitting an information signal is also described.

Electrically operated kitchen appliances are already well known, particularly for processing raw or semi-finished food products. Such kitchen appliances often have a base unit with which separate functional parts interact in order to process a food product depending on the dish, drink or similar. These functional parts are usually sold by kitchen appliance suppliers as accessory parts, for example as a lid, blade or stirring unit.

### DESCRIPTION OF RELATED ART

In order to keep the manufacturing costs of these accessory parts low and thus also increase the profitability of the accessory parts business, the base unit should be versatile and have as many of the more cost-intensive components as possible, such as the electric motor for driving the moving parts of the accessory parts or a controller. However, such a design enables competitors to offer accessory parts that are compatible with the cost-intensive base unit but are cheaper to manufacture. It has already been suggested that an NFC transponder (Near Field Communication transponder) could be attached to the accessory part and a corresponding reader module to the base unit in order to recognise the accessory part as “permissible” or not. This solution is explained in detail in the publication EP 3 841 926 A1.

However, the fact that the accessory parts are often used in the holding space of a receiving vessel of the kitchen appliance remains problematic, whereby the receiving vessel, which is usually used to hold hot food, is made of a material such as metal that is at least partially impermeable to electromagnetic waves. Thus, an NFC transponder of an accessory part, which is arranged on one side of the wall of the receiving vessel, is predominantly shielded from the excitation signal of an NFC reader module, which is arranged on the other side of the wall of the receiving vessel, which prevents the accessory part from being recognised. The publication EP 3 841 926 A1 proposes redirecting the excitation signal of the reader module via a repeater module in a lid of the kitchen appliance in order to bypass the wall of the receiving vessel. For this solution, however, the lid must be arranged accordingly.

Against this background, the present invention is based on the task of improving previously known kitchen appliances, in particular increasing user-friendliness when inserting accessory parts.

### SUMMARY OF THE INVENTION

According to the invention, this task is solved by a kitchen appliance having a base unit, the base unit having a first communication module which is configured for wireless communication, having a receiving vessel, the receiving vessel having a wall with a penetrating opening, and having an accessory part, the accessory part having a second communication module which is configured for wireless communication, characterised in that a connecting element is provided, wherein the connecting element is adapted for arrangement in the penetrating opening of the wall of the receiving vessel, and wherein the connecting element is configured for transmitting signals between the first communication module and the second communication module.

This allows an accessory part to be easily and confidently recognised without the need to place a lid on the receiving vessel or equip the handle with electronic elements. In addition, a receiving vessel that already has a penetrating opening in the wall, for example to enable an accessory part with the drive of the base unit, can continue to be used. Overall, the invention allows existing kitchen appliances to be easily converted and at the same time increases user-friendliness.

A base unit within the meaning of the present invention is preferably adapted as a base for the use of a receiving vessel and accessory parts. The base unit has a housing in which an electric motor for driving accessory parts is arranged.

The receiving vessel has a wall that at least partially surrounds a receiving space for holding food. Preferably, the wall comprises a bottom and walls that are formed in one piece or in several pieces as separate parts. For example, a handle or a false bottom can be attached to the wall. In particular, a heater can be provided at the bottom. Furthermore, the handle or the false bottom can be made of a thermally insulating material in order to reduce the risk of burns to a user or a kitchen worktop. Furthermore, the wall or bottom of the receiving vessel or the false bottom can be adapted in such a way that it forms an interface for mechanical connection to the housing of the base unit.

The wall of the receiving vessel has a penetrating opening. Preferably, the penetrating opening is formed in the bottom, in particular if the receiving vessel is intended for connection to the base unit in the bottom area. Alternatively, the penetrating opening can be provided on a side wall of the wall. In this case, the sealing requirements for foodstuffs held in the receiving space of the receiving vessel are less stringent, making the kitchen appliance easier to manufacture.

An accessory part is understood to be any part adapted to interact with the base unit. The term “interaction” includes, among other things, the actions from the list: connecting, coupling, mounting on, fitting, attaching, mounting at and the like. In particular, an accessory part is adapted to extend the function of the base unit, for example as a cutting, stirring, cooking, weighing, slow cooking, steaming or covering unit.

The base unit and the accessory part each have a communication module configured for wireless communication. The first communication module of the base unit and the second communication module of the accessory part are preferably configured to exchange signals with each other wirelessly. In particular, the first communication module is configured to emit an excitation signal, for example a high-frequency alternating electromagnetic field, and to receive and evaluate a modulated response signal. The second communication module is preferably configured to modulate an excitation signal from the first communication module and to output it as a modulated response signal.

A connecting element within the meaning of the present invention is an element which is suitable for ensuring a communication connection between the accessory part and the base unit. It is provided that the connecting element is adapted to be arranged in the penetrating opening of the wall of the receiving vessel. In this way, the connecting element can transmit a signal, in particular in the form of an electromagnetic wave, which has been emitted by the first communication module of the base unit on one side of the wall, through the wall and forward it to the second communication module of the accessory part. This also applies in the opposite direction, i.e. for a signal that is transmitted from the second communication module of the accessory part in the direction of the first communication module of the base unit.

For arrangement in the penetrating opening of the wall of the receiving vessel, the connecting element preferably has a base body with a shape that is adapted, at least in sections, to the shape of the penetrating opening. A sealing element can be provided between the base body of the connecting element and the inner wall of the opening.

Alternatively or additionally, the connecting element may have a cap which, in an assembled state of the connecting element in the penetrating opening of the wall of the receiving vessel, contributes to sealing the opening. Preferably, the cap is made of a material that is resistant to mechanical stresses that occur during food preparation in the receiving vessel and that is at least partially permeable to electromagnetic waves. Examples of such materials are polymer materials, silicone, ceramic or a combination thereof.

In a first embodiment of the kitchen appliance, the wall of the receiving vessel is at least partially formed from a material that is at least partially impermeable to electromagnetic waves.

The permeability of a material to electromagnetic waves or fields depends on the conductivity and permeability of the material as well as the frequency of the waves or field. For electromagnetic waves or fields emitted by a near-field communication transceiver, stainless steel is essentially impermeable or predominantly attenuates these waves. In the context of the present invention, stainless steel has been found to be substantially impermeable to electromagnetic waves having a frequency of about 13.56 MHz. The substantial impermeability of the material was tested on areas of the wall of the receiving vessel that do not have a penetrating opening. Preferably, the material is also suitable for holding food hygienically, especially at elevated temperatures that regularly occur during food preparation.

In a further embodiment of the kitchen appliance, the connecting element has a first communication element and a second communication element, wherein the first communication element is configured for wireless communication with the first communication module of the base unit and the second communication element is configured for wireless communication with the second communication module of the accessory part, and wherein the first communication element and the second communication element are connected via a cable connection.

As a result, depending on the dimensions of the cable connection, the size of the penetrating opening in the wall of the receiving vessel can be kept small in order to ensure a higher tightness of the receiving vessel. In addition, the first communication element and the second communication element can be formed simply and inexpensively in this way, whereby a signal can be reliably transmitted from one to the other.

In a further embodiment of the kitchen appliance, the first communication module of the base unit is a near-field communication reader module, in particular an RFID (Radio-Frequency Identification) reader module or an NFC (Near Field Communication) reader module, the second communication module of the accessory part is a near-field communication transponder, in particular an RFID transponder or an NFC transponder, and the first communication element, the second communication element and their connection form a passive near-field repeating module, in particular an RFID repeating module or an NFC repeating module.

So-called RFID transceivers, transponders and repeaters are freely available on the market, easy to manufacture at low cost and robust in use. Corresponding NFC modules are also available. They also offer a signal transmission range that is suitable for kitchen appliances of this type. The RFID or NFC transponder can be passive or active.

In the context of the present invention, “near-field communication” (abbreviated to NFC) is understood to mean an international transmission standard based on radio-frequency identification (RFID) technology for the contactless exchange of data by electromagnetic induction using loosely coupled coils over short distances of a few centimetres and a data transmission rate of a maximum of 424 kbit/s. Data is exchanged by the second communication module modulating an electromagnetic field generated by the first communication module, whereby this modulation can in turn be detected by the first communication module.

In a further embodiment of the kitchen appliance, the connecting element comprises a base body having a first distal portion, a transition portion and a second distal portion, wherein the first distal portion and the second distal portion are arranged in opposite directions and the transition portion connects the first distal portion and the second distal portion, wherein the transition portion is adapted to be arranged in the penetrating opening in the wall of the receiving vessel. Furthermore, the first communication element is arranged at the first distal portion and the second communication element is arranged at the second distal portion.

In this way, the first communication element and the second communication element can each be arranged on one side of the wall of the receiving vessel. Thus, in particular, the obstacle formed by a receiving vessel made of a shielding material can be overcome for signal exchange. In particular, signals can then be transmitted between the first communication module of the base unit and the second communication module of the accessory part without the signals being diverted around the wall of the receiving vessel, for example via the handle or the lid.

The adjective “distal” is preferably to be understood as “away from the centre of the main body”. The transition portion forms a transition between the first distal portion and the second distal portion. Furthermore, the first distal portion, the transition portion and the second distal portion can be formed in one piece, for example in the form of a shaft or a transmission element with a force transmission profile, in particular with a screw entrainment profile. This can simplify the connection between the first communication element and the second communication element.

In a further embodiment of the kitchen appliance, the transition portion has a cable guide and the cable guide guides the cable connection between the first communication element and the second communication element.

The cable guide can be a channel, for example a hole, which crosses the transition portion from the first distal portion to the second distal portion of the base body of the connecting element. This design of the cable guide enables a sealed connection between the two communication elements of the connecting element that is electrically insulated from its surroundings and therefore reliable and durable.

Alternatively or additionally, the cable guide can be a recess in an outer surface of a component of the connecting element, which is intended to accommodate the cable connection. Preferably, the recess extends from the position of the first communication element to the position of the second communication element. Furthermore, the recess, which is accommodated in the cable connection, can be filled with an insulating material. The insulating material thus seals the recess with the cable connection or electrically insulates the cable connection from the environment.

In a further embodiment of the kitchen appliance, the cable connection has a coaxial conductor. In this case, the connecting element or the base body of the connecting element has at least partially an electrically conductive material and the coaxial conductor is at least partially formed by the electrically conductive material of the base body of the connecting element.

In this way, the connecting element can be adapted more compactly, in particular without a separate cable.

In a further embodiment of the kitchen appliance, the base unit has a drive and the connecting element or the base body of the connecting element is adapted to transmit a drive force from the drive of the base unit to the accessory part.

This way a connecting element, which is already provided in a generic kitchen appliance for driving the accessory part, can simply be replaced or retrofitted in order to connect the base unit to the accessory part both mechanically and in terms of signalling. It is particularly advantageous that the base unit, the accessory part and the receiving vessel of kitchen appliances already available on the market can continue to be used unchanged and only the connecting element needs to be replaced.

A connecting element according to this embodiment of the kitchen appliance can, for example, have a first distal portion in the form of a transmission element with a screw drive profile for connection to the drive of the base unit, a second distal portion in the form of an interface element for a mechanical connection to an accessory part and a transition portion in the form of a shaft that carries a blade unit. The first communication element can be a coil on the interface element and the second communication element can be a coil on the transmission element.

According to the invention, the above-mentioned task is also solved by a connecting element for a kitchen appliance with a base body, wherein the base body is at least partially adapted for arrangement in a penetrating opening in the wall of a receiving vessel of the kitchen appliance, in that a first communication element configured for wireless communication and a second communication element configured for wireless communication are provided, and in that the first communication element and the second communication element are connected via a cable connection.

Such connecting elements are suitable for simplifying the design of kitchen appliances with an accessory part recognition system. In particular, the remaining parts of a kitchen appliance, such as the receiving vessel, can be adopted unchanged in comparison to already available kitchen appliances. Existing kitchen appliances can also be easily retrofitted or converted using the connecting element.

Furthermore, the connecting element and its embodiments from the following paragraphs offer the same advantages as the kitchen system and the corresponding embodiments of the kitchen system.

In a first embodiment of the connection part, the first communication element, the second communication element and their connection form a passive near-field repeating module, in particular an RFID repeating module or an NFC repeating module.

This means that robust and easily available modules can be installed and the connecting element can be manufactured simply and cost-effectively.

In a further embodiment of the connecting part, the base body has a first distal portion, a transition portion and a second distal portion, wherein the first distal portion and the second distal portion are arranged in opposite directions and the transition portion connects the first distal portion and the second distal portion, and wherein the transition portion is adapted to be arranged in the penetrating opening in the wall of a receiving vessel of the kitchen appliance. Further, the first communication element is arranged at the first distal portion and the second communication element is arranged at the second distal portion.

In a further embodiment of the connecting part, the transition portion has a cable guide and the cable guide guides the cable connection between the first communication element and the second communication element.

In a further embodiment of the connecting part, the cable connection has a coaxial conductor, the base body has at least partially an electrically conductive material and the coaxial conductor is formed at least partially by the electrically conductive material of the base body of the connecting element. In particular, the base body can have a shaft that is adapted to transmit a driving force and with a composition comprising a metal.

In a further embodiment of the connecting part, the base body has a transmission element for transmitting a drive force from the first distal portion to the second distal portion.

In a further embodiment of the connecting part, the connecting element has a blade unit and the transmission element is adapted to transmit a drive force from the drive of the base unit to the blade unit.

In this way, both the blade unit and an accessory part that is mechanically compatible with the connecting element can be driven or set in motion by the drive of the base unit.

Furthermore, the above task is also solved by a method for transmitting an information signal between a first communication module of a base unit of a kitchen appliance, which first communication module is configured for wireless communication, and a second communication module of an accessory part of the kitchen appliance, which second communication module is configured for wireless communication, in which a signal is transmitted between the first communication module and the second communication module by means of a connecting element according to one of the embodiments described above.

The process also offers the same advantages as the kitchen appliance and the connecting element in the previous paragraphs.

### BRIEF DESCRIPTION OF THE DRAWINGS

The features of the kitchen appliance, the connecting element and the method can be combined with each other as desired. Further features and advantages of the kitchen appliance, the connecting element and the method are explained in the following description, with reference being made to the attached drawing. The drawing shows

FIG. 1 a first example of a kitchen appliance with a connecting element,

FIG. 1a a detailed view of the kitchen appliance shown in FIG. 1,

FIG. 2 a first example of a connecting element,

FIG. 3 a second example of a connecting element,

FIG. 3a the component of the connecting element from FIG. 3 in a first perspective view and without insulating material,

FIG. 3b the component from FIG. 3a in a second perspective view and without insulation material,

FIG. 3c the component from FIG. 3a with insulation material,

FIG. 3d the component from FIG. 3b with insulation material,

FIG. 4 a third example of a connecting element,

FIG. 5 a second example of a kitchen appliance with a connecting element.

### DESCRIPTION OF THE INVENTION

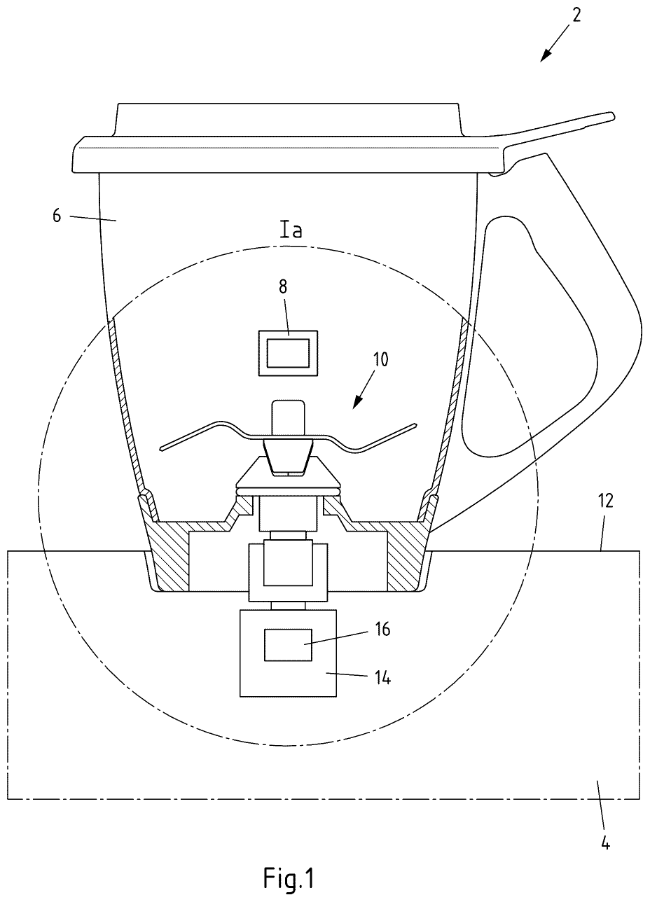

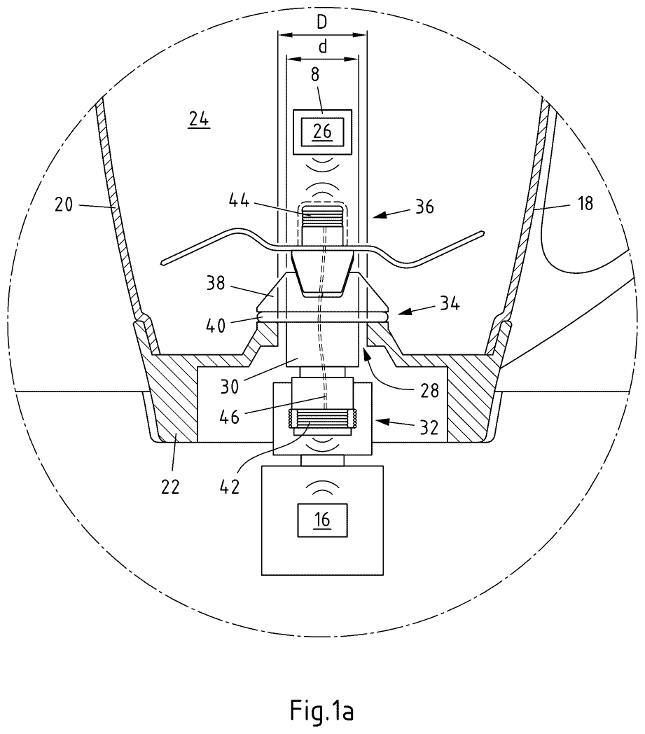

FIG. 1 shows a kitchen appliance 2 with a base unit 4, with a receiving vessel 6, with an accessory part 8 and with a connecting element 10. The base unit 4 has a housing 12, a drive 14 and a first communication module 16 in the form of an RFID transceiver configured for wireless communication. The portion Ia of the kitchen appliance is shown in further detail in FIG. 1a.

The receiving vessel 6 is adapted to receive food or ingredients for carrying out a preparation process. In particular, the receiving vessel 6 is adapted to hold liquids and hot ingredients and has a wall 18 made of stainless steel. The wall 18 is formed in one piece with lateral walls 20 and a base 22, wherein the wall 18 has an upper opening for receiving food. Furthermore, a heater (not shown) is integrated into the base 22 for heating the received foodstuffs.

The accessory part 8 is intended for use in the receiving space 24 of the receiving vessel 6 and to supplement the function of the kitchen appliance 2. Here, the accessory part 8 can, for example, take the form of a stirring, cutting, peeling or weighing or covering unit. The accessory part 8 has a second communication module 26 configured for wireless communication, in this case in the form of an RFID transponder.

Due to its composition with stainless steel, the wall 18 of the receiving vessel 6 at least partially obstructs the path of electromagnetic waves between both sides of the wall 18. In order to overcome this obstruction, the wall 18 of the receiving vessel 6 shown in FIG. 1 and FIG. 1a has a penetrating opening 28 in which the connecting element 10 is accommodated.

The connecting element 10 has a base body 30 with a first distal portion 32, with a transition portion 34 and with a second distal portion 36. The first distal portion 32 and the second distal portion 36 are arranged in opposite directions. The transition portion 34 connects the first distal portion 32 and the second distal portion 36. Furthermore, the transition portion 34 has an outer diameter d which is adapted to the inner diameter D of the penetrating opening 28 of the wall 18 of the receiving vessel 6. In addition, a cap 38 with a sealing element 40 is provided in the region in which the transition portion 34 and the second distal end merge into one another, which ensures a tight connection of the connecting element 10 to the wall 18 or the base 22 of the receiving vessel 6.

The connecting element 10 comprises a first communication element 42 at the first distal portion 32 and a second communication element 44 at the second distal portion 36. The first communication element 42 is configured for wireless communication with the first communication module 16 of the base unit 4. In addition, the second communication element 44 is configured for wireless communication with the second communication module 26 of the accessory part 8. The first communication element 42 and the second communication element 44 are connected via a cable connection 46. The first communication element 42, the second communication element 44 and the cable connection 46 form a passive RFID repeating module, which is suitable for transmitting a signal between the first communication module 16 of the base unit 4 and the second communication module 26 of the accessory part 8.

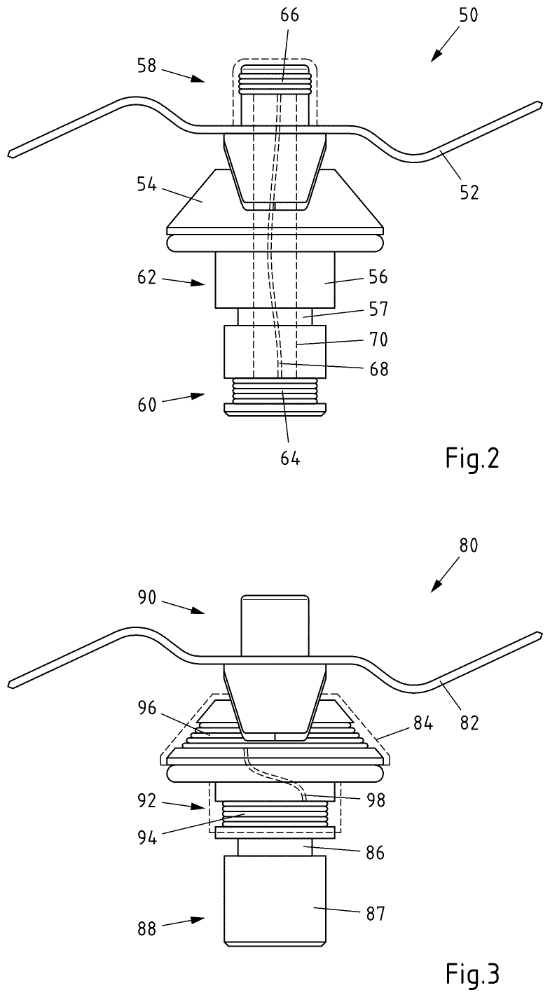

FIG. 2 shows a first example of a connecting element 50, which is adapted with a blade unit 52, with a sealing cap 54 and with a base body 56 in the form of a transmission element 57. The transmission element 57 is, in turn, formed as a shaft. The connecting element 50 has a first distal portion 58, a second distal portion 60 and a transition portion 62 connecting these sections 58, 60. In addition, the connecting element 50 has a first communication element 64 and a second communication element 66, which are arranged respectively at the first distal portion 58 and at the second distal portion 60. Both communication elements 64, 66 are configured for signal transmission with further NFC elements or modules by means of NFC technology. Furthermore, the first communication element 64 and the second communication element 66 are connected via a cable connection 68, which is arranged in a cable guide 70 formed as a bore through the transmission element 57.

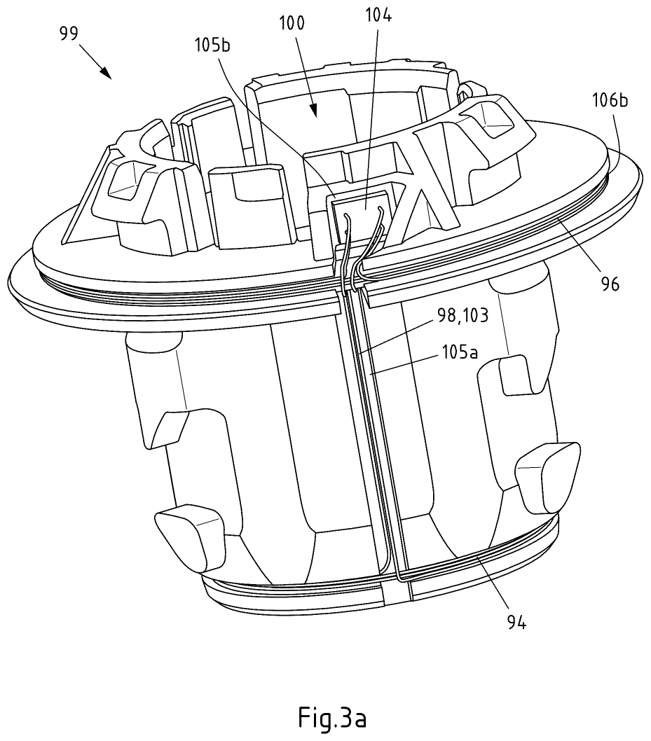

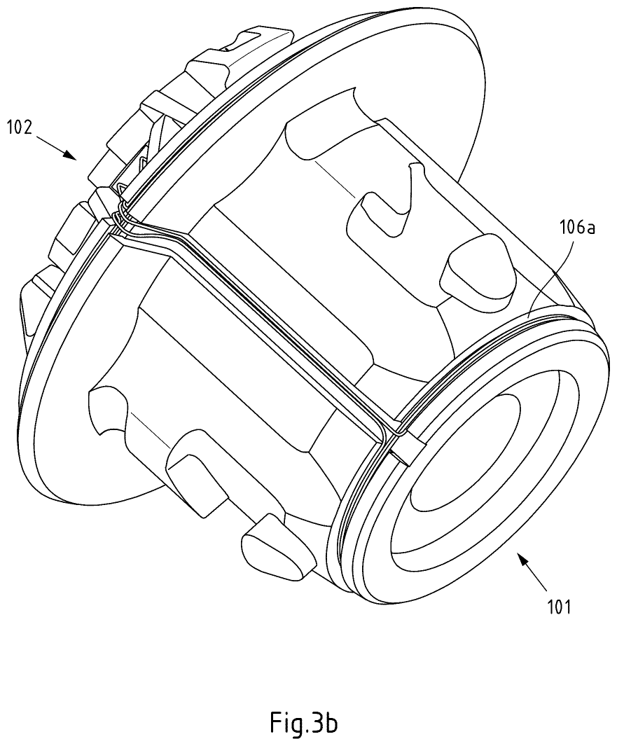

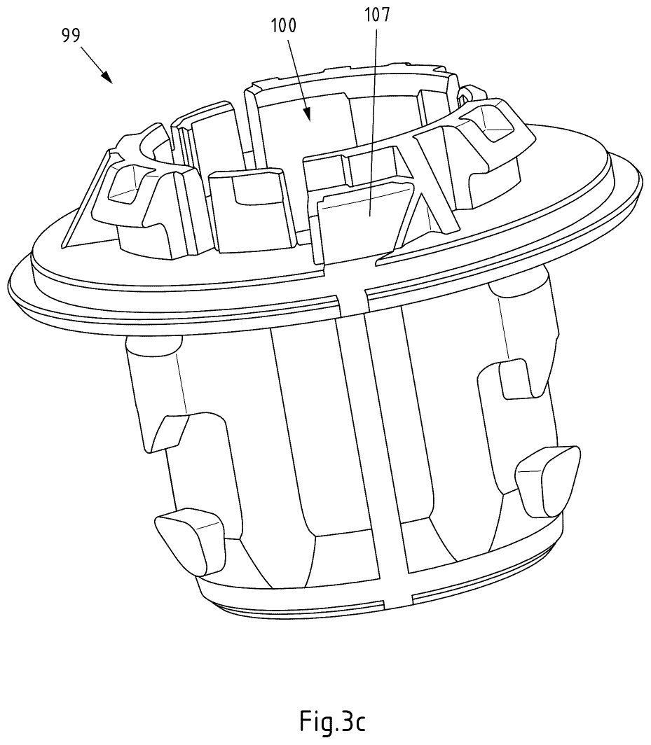

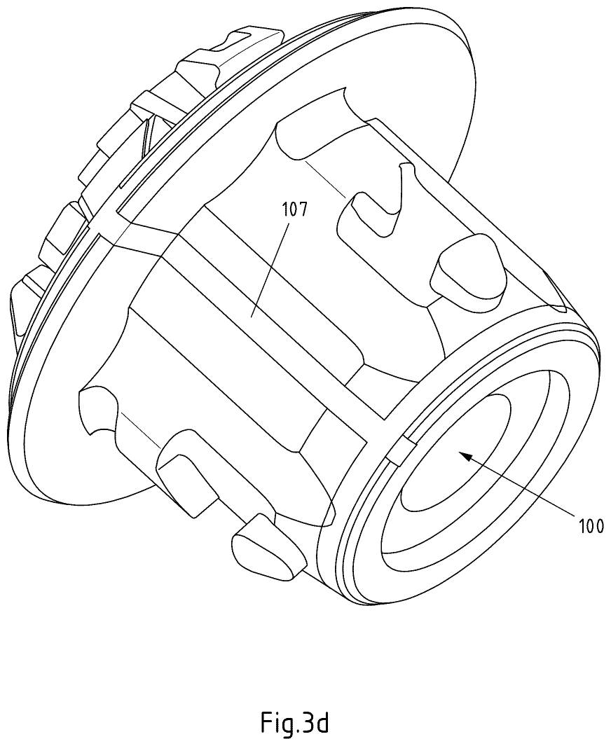

FIG. 3 shows a second example of a connecting element 80, which is also formed with a blade unit 82, with a sealing cap 84 and with a base body 86 in the form of a transmission element 87. The sealing cap 84 is intended to withstand the mechanical stresses occurring during a preparation process and at the same time be at least partially permeable to electromagnetic waves. In the present case, the sealing cap 84 is essentially made of plastic.

The connecting element 80 has a first distal portion 88, a second distal portion 90 and a transition portion 92. A first NFC communication element 94 and a second NFC communication element 96 are also provided here, which are connected by means of a cable connection 98. In contrast to the connecting element 50 of FIG. 2, the first communication element 94 and the second communication element 96 are arranged closer to each other and to the transition portion 92.

In particular, the second communication element 96 is arranged behind the blade unit 82 and the sealing cap 84, as viewed from the second distal portion 90. This enables better manufacturability of the connecting element 80.

FIG. 3a, FIG. 3b, FIG. 3c and FIG. 3d show a component 99 of the connecting element 80 of FIG. 3. The component 99 is formed as a blade bearing holder and has a central, through-going opening 100, which is adapted to receive a shaft. In FIGS. 3a and 3c, the component 99 is shown in a first perspective view and in FIGS. 3b and 3d in a second perspective view. Furthermore, FIGS. 3a and 3b show the component 99 without insulating material, while FIGS. 3c and 3d show the component 99 with insulating material.

The first NFC communication element 94 is arranged at a first end 101 of the component 99. The first NFC communication element 94 is connected via the cable connection 98 to the second NFC communication element 96, which is arranged at a second end 102 of the component 99. The cable connection 98 is formed as a cable 103 with a capacitor PCB 104, wherein both the cable 103 and the capacitor PCB 104 are each arranged in a recess 105a, 105b in the mass of the component 99. The cable connection 98 and the recesses 105a, 105b together extend from the first end 101 to the second end 102 of the component 99. The first NFC communication element 94 and the second NFC communication element 96 are each embedded in recesses 106a, 106b in the mass of the component 99.

In the recesses 105a, 105b, 106a and 106b, insulating material 107, in this case silicone, has been applied by a so-called “over-moulding” process, so that the first NFC communication element 94, the second NFC communication element 96, the cable connection 98 and their connections are electrically insulated from the environment and protected against mechanical stresses.

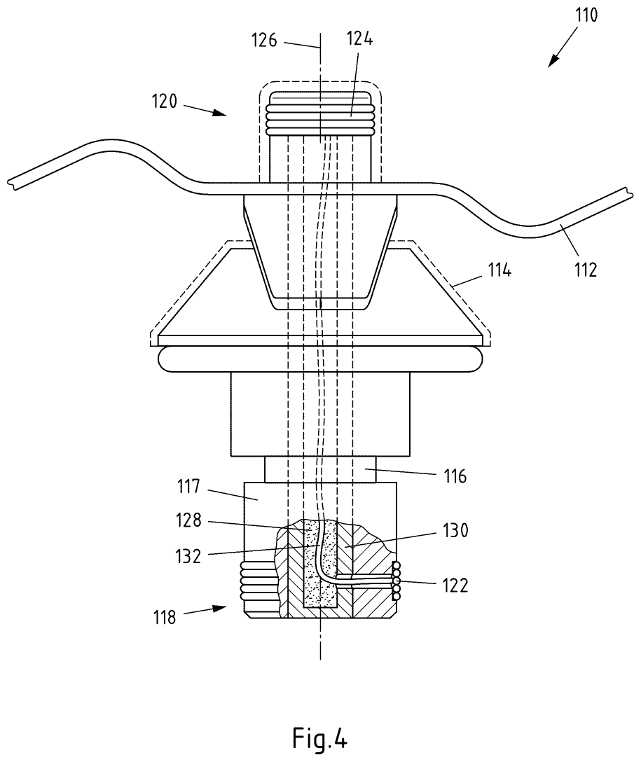

FIG. 4 shows a third example of a connecting element 110, which has a blade unit 112, a sealing cap 114 and a base body 116 in the form of a transmission element 117. The transmission element 117 is formed as a shaft with a first distal portion 118 and with a second distal portion 120, wherein the first distal portion 118 of the transmission element 117 is at the same time the first distal portion of the connecting element 110. This also applies to the second distal portion 120 of the transmission element 117 or the connecting element 110.

Furthermore, a first communication element 122 is arranged at the first distal portion 118 and a second communication element 124 is arranged at the second distal portion 120. The transmission element has a core 128 made of an electrically insulating material extending along the main extension axis 126 of the transmission element 117 and a wall 130 made of an electrically conductive material arranged around the core 128. In addition, a cable connection 132 extends through the core 128. Both the wall 130 of the transmission element 117 and the cable connection 132 are connected to both communication elements 122, 124, so that the wall 130 of the transmission element 117 and the cable connection 132 together form a coaxial conductor between the first and second communication elements 122, 124.

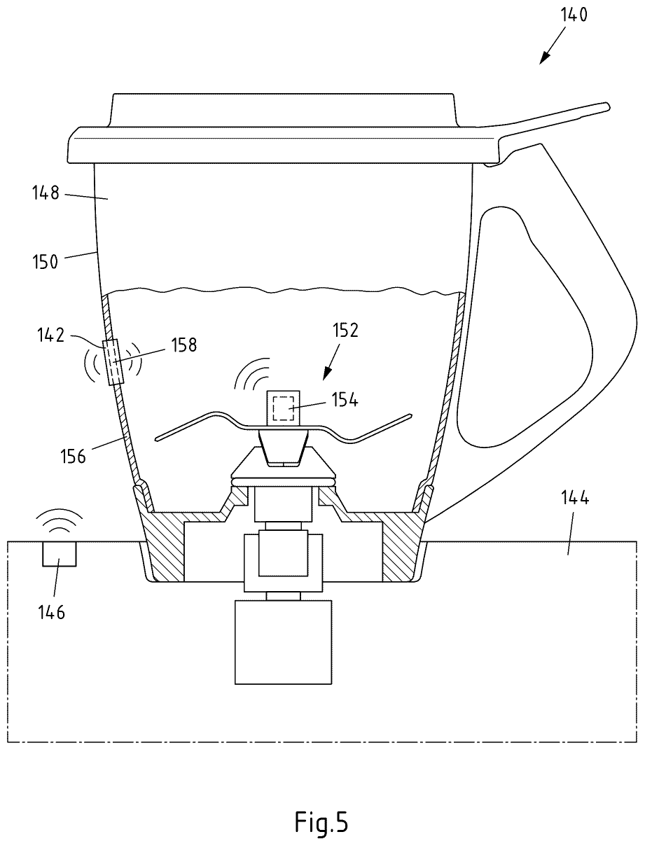

FIG. 5 shows a second example of a kitchen appliance 140 having a connecting element 142. The kitchen appliance 140 comprises a base unit 144 having a first communication module 146 adapted for wireless communication, a receiving vessel 148 having a wall 150, and an accessory part 152, the accessory part 152 having a second communication module 154 adapted for wireless communication. A penetrating opening 158 is provided in a side wall 156 of the wall 150 of the receiving vessel 148.

The connecting element 142 is configured as a repeating module or for transmitting signals between the first and second communication modules 146, 154 and is arranged in the penetrating opening 158 of the wall 150.

1. A kitchen appliance
with a base unit, wherein the base unit has a first communication module configured for wireless communication,
with a receiving vessel, wherein the receiving vessel has a wall with a penetrating opening and
with an accessory part, wherein the accessory part has a second communication module configured for wireless communication, wherein
a connecting element is provided,
the connecting element is adapted for arrangement in the penetrating opening of the wall of the receiving vessel, and
the connecting element is configured for transmitting signals between the first communication module and the second communication module.

2. The kitchen appliance according to claim 1, wherein
the wall of the receiving vessel is formed at least partially from a material which is at least partially impermeable to electromagnetic waves.

3. The kitchen appliance according to claim 1, wherein
the connecting element comprises a first communication element and a second communication element,
the first communication element is configured for wireless communication with the first communication module of the base unit and the second communication element is configured for wireless communication with the second communication module of the accessory part, and
the first communication element and the second communication element are connected via a cable connection.

4. The kitchen appliance according to claim 3, wherein
the first communication module of the base unit is a near-field communication reader module, in particular an RFID reader module or an NFC reader module,
the second communication module of the accessory part is a near-field communication transponder, in particular an RFID transponder or an NFC transponder, and
the first communication element, the second communication element and their connection form a passive near-field repeating module, in particular an RFID repeating module or an NFC repeating module.

5. The kitchen appliance according to claim 1, wherein
the connecting element has a base body with a first distal portion, with a transition portion and with a second distal portion,
the first distal portion and the second distal portion are arranged in opposite directions and the transition portion connects the first distal portion and the second distal portion,
the transition portion is adapted to be disposed in the penetrating opening in the wall of the receiving vessel, and
the first communication element is arranged at the first distal portion and the second communication element is arranged at the second distal portion.

6. The kitchen appliance according to claim 5, wherein
the transition portion has a cable guide, and
the cable guide guides the cable connection between the first communication element and the second communication element.

7. The kitchen appliance according to claim 3, wherein
the cable connection has a coaxial conductor,
the connecting element or the base body of the connecting element has at least partially an electrically conductive material, and
the coaxial conductor is formed at least partially by the electrically conductive material of the base body of the connecting element.

8. The kitchen appliance according to claim 1, wherein
the base unit has a drive, and
the connecting element is adapted to transmit a drive force from the drive of the base unit to the accessory part.

9. A connecting element for a kitchen appliance
with a base body,
wherein the base body is formed at least partially for arrangement in a penetrating opening in the wall of a receiving vessel of the kitchen appliance, wherein
a first communication element adapted for wireless communication and a second communication element adapted for wireless communication are provided, and
the first communication element and the second communication element are connected via a cable connection.

10. The connecting element according to claim 9, wherein
the first communication element, the second communication element and their connection form a passive near-field repeating module, in particular an RFID or NFC repeating module.

11. The connecting element according to claim 9, wherein
the base body has a first distal portion, a transition portion and a second distal portion,
the first distal portion and the second distal portion are arranged in opposite directions and the transition portion connects the first distal portion and the second distal portion, and
the transition portion is adapted for arrangement in the penetrating opening in the wall of a receiving vessel of the kitchen appliance,
the first communication element is arranged at the first distal portion, and
the second communication element is arranged at the second distal portion.

12. The connecting element according to claim 11, wherein
the transition portion has a cable guide, and
the cable guide guides the cable connection between the first communication element and the second communication element.

13. The connecting element according to claim 9, wherein
the cable connection has a coaxial conductor,
the base body at least partially comprises an electrically conductive material, and
the coaxial conductor is formed at least partially by the electrically conductive material of the base body of the connecting element.

14. The connecting element according to claim 9, wherein
the base body has a transmission element for transmitting a driving force from the first distal portion to the second distal portion.

15. The connecting element according to claim 14, wherein
the connecting element has a blade unit, and
the transmission element is adapted to transmit a drive force from the drive of the base unit to the blade unit.

16. A method for transmitting an information signal between a first communication module of a base unit of a kitchen appliance, which is configured for wireless communication, and a second communication module of an accessory part of the kitchen appliance, which is configured for wireless communication,
wherein a signal is transmitted between the first communication module and the second communication module by means of a connecting element according to claim 9.
